(19) United States
(12) Patent Application Publication
(10) Pub. No.: US 2004/0143030 A1
(43) Pub. Date: Jul. 22, 2004

(54) Method of producing synthetic polymer gel and said gel

(76) Inventor: Fumiyoshi Ikkai, Ibaraki (JP)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 10/659,360

(22) Filed: Sep. 11, 2003

Related U.S. Application Data
(60) Provisional application No. 60/416,591, filed on Oct. 8, 2002.

(30) Foreign Application Priority Data
Sep. 11, 2002 (JP) 2002-265123

(51) Int. Cl. C08F 2/46

(52) U.S. Cl. 522/49

(57) ABSTRACT

Disclosed herein is a method of producing a hydrogel without using crosslinking agents or reducing agents of low-temperature redox initiators as used in conventional gelation, for example, without detrimentally influencing the state of emulsion in emulsion polymerization, and capable of conveniently forming a crosslinked synthetic polymer.

Thus, disclosed herein is a method for producing a synthetic polymer gel, comprising steps of preparing an aqueous solution comprising at least one persulfate and at least one type of water-soluble vinyl monomer chosen from among compounds having an acryloyl structure, then irradiating said aqueous solution with UV light. Also disclosed is the optional method further comprising a step of preparing an emulsion wherein said aqueous solution is emulsified in a water-immiscible medium.

This application claims benefit of U.S. Provisional Application No. 60/416,591 filed Oct. 8, 2002.

The present disclosure relates to a method of producing a synthetic polymer gel. In addition, the present disclosure relates to a method for obtaining a hydrogel by UV irradiation of an aqueous solution comprising at least one persulfate and at least one water-soluble vinyl monomer having a specific structure.

Synthetic polymer gels, for example hydrogels, can serve a variety of functions based on properties such as water retention properties, flexability, and elastic properties as well as their ability to provide controlled release of encapsulated agents, and therefore can be used for diverse applications in fields such as medicine and hygiene, cosmetics, food processing, machinery, construction, and agriculture.

Hydrogels comprising synthetic polymers are believed to be formed by insoluble three-dimensional network structures made up of constituent synthetic polymer chains that are swollen with water. In these three-dimensional network structures, polymer chains can bind together by covalent bonds, hydrogen bonds, coordinate bonds or Coulomb bonds, and groups of polymer chains are coagulated or intertwined together.

For example, hydrogels comprising synthetic polymers crosslinked by covalent bonds can be employed for a wide range of uses due to their good stability. The production of such synthetic polymer gels with covalent bonds has generally been by (1) methods wherein crosslinking progresses simultaneous to polymerization of monomers, and (2) methods of generating crosslinked bonds between polymerized macromolecular chains.

In general, polymerization reactions are made up of a number of elementary reactions including an initiation reaction, a propagation reaction, a chain transfer reaction and a termination reaction, and in the initiation reaction for radical polymerization, a radical-generating compound known as an initiator is generally used.

When energy in the form of heat or light is applied to a monomer solution containing an initiator, the initiator can cleave to create radicals, and these radicals will attack (vinyl) monomer double bonds to generate monomer radicals, which will in turn attack subsequent monomers. This chain reaction can continue to propagate and build up polymer chains until a chain transfer reaction to another molecule or a termination reaction, such as disproportionation, finally causes the polymerization to cease.

If at least two types of monomer exist in the polymerization solution, the different types of monomer in the propagation reaction will bind together to form copolymers. When this occurs, differences in the reactivity (copolymerizability) of the existing monomers can cause differences in the proportion of monomers forming the final polymer chains or prevent the polymerization from proceeding far enough.

In the above-described method (1), crosslinking agents such as divinyl compounds or the like can be added to the monomer solution to induce a crosslinking reaction simultaneous to the polymerization of the monomers. When this is the case, the reactivity of the monomers and crosslinking agents being used may need to be adjusted in order to obtain the desired crosslinked polymer.

Furthermore, in emulsion polymerization wherein a monomer solution is dispersed in the medium, there are cases in which raising the temperature of the medium will disrupt the balance at the boundary and make it impossible to maintain a good state of dispersion. Consequently, in emulsion polymerization, a low-temperature initiator (redox initiator) comprising a peroxide that decomposes in the presence of a reducing agent is often used.

A redox initiator is a combination of an oxidizing agent such as a persulfate or hydrogen peroxide, and an inorganic reducing agent such as a water-soluble ferrous salt or NaHSO₃, or an organic reducing agent such as alcohol or polyamine. By using this initiator, radicals can be formed by an electron transfer from the reducing agent to the oxidizing agent, and these radicals initiate the polymerization reaction of the monomers. However, there are cases in which an emulsive state cannot be maintained due to action of the reducing agent contained in the redox initiator, or the surfactant used to form the emulsion.

On the other hand, in the above-described method (2), reactive functional groups must be preattached to the polymer chains in order to enable a crosslinking reaction to occur between the polymer chains, and there is the risk of unreacted functional groups that remain after crosslinking having a detrimental effect on the properties of the gel.

Therefore, there has been a demand for a method of producing a gel which, for example in the case of emulsion polymerization, does not have a detrimental effect on the state of emulsion, and is also able to conveniently form a crosslinked synthetic polymers gel.

The above-described problems can be resolved by the present disclosure. That is, disclosed herein is a method of producing a synthetic polymer gel comprising the preparation of an aqueous solution comprising at least one persulfate and at least one type of water-soluble vinyl monomer having an acryloyl (CH₂═CHCO—) structure, and irradiating said aqueous solution with UV light to form a gel.

### BRIEF DESCRIPTION OF THE DRAWING

FIG. 1 is a graph showing the absorption spectrum of ammonium persulfate (APS) in UV light (wavelength 200-370 nm).

By using the method of the present disclosure, crosslinking agents and redox initiators, as well as y-ray treatments, which are generally used for the production of conventional synthetic polymer gels, may be unnecessary, so that synthetic polymer gels can be be produced in a convenient manner and stable form. According to the present disclosure, it is possible to gelate an aqueous solution that does not comprise any additives (such as crosslinking agents or redox initiators), resulting in a pure hydrogel comprising a crosslinked polymer comprising the vinyl monomers. (However, this disclosure does not preclude the addition of desired additives such as those described later.)

In one aspect of the method of producing a synthetic polymer gel (hydrogel) according to the present disclosure, a water-soluble compound believed to function as an initiator, for example, an aqueous solution of a persulfate and a water-soluble vinyl monomer having the above-described specific structure is first prepared.

The vinyl monomers that can be used are not restricted as long as they have an acryloyl structure and are water-soluble. However, non-limiting mention may be made of those having a structure expressed by the following formula (I):

CH₂═CHCO—R (I)

wherein

R is an entity chosen from: OH, R₁, OR₁, NH₂, NH-R₁ and N-R₁R₂,

wherein R₁ and R₂, which may be identical or different, may be chosen from straight, branched, and cyclic alkyl groups, alkoxyl groups comprising from 1-10 carbon atoms, for example, 1-8, such as, 1-6, and for further example, 1-4 carbon atoms, which may optionally comprise at least one hetero atom such as O, S and N in the chain, and may optionally be substituted with at least one entity chosen from halogen atoms, hydroxyl groups, carboxyl groups, formyl groups and amino groups.

The term “water-soluble” as used herein is understood as meaning soluble in water without heating (at room temperature).

Among the water-soluble monomers suitable for use in the present disclosure, mention may be made of, for example, acrylic acid; acrylamide; N-alkylacrylamide, such as N-isopropylacrylamide, N-hexylacrylamide, N-ethylacrylamide and N-methylacrylamide; N,N-dialkylacrylamide, such as N,N-diisopropylacrylamide, N,N-dihexylacrylamide, N,N-diethylacrylamide, N,N-dimethylacrylamide, N-methyl-N-ethylacrylamide, N-ethyl-N-hexylacrylamide and 4-acryloylmorpholine; acrylic esters including alkyl acrylate, such as isopropylacrylate, hexylacrylate, ethylacrylate, 2-(dimethylamino)ethylacrylate, and 2-hydroxyethylacrylate.

The concentration of the water-soluble vinyl monomer may be generally ranging from 300-1200 mM, for example 500-1000 mM, such as 700-800 mM in the aqueous solution to be gelled. However, depending on conditions such as the polymerization system (solution polymerization, suspension polymerization or emulsion polymerization), or the desired degree of polymerization or crosslinking (or gelation), or the concentration of the persulfates being used, a concentration outside the above-given range may also be used.

The aqueous solution prepared herein comprises at least one type of persulfate in addition to the aforementioned water-soluble vinyl monomer.

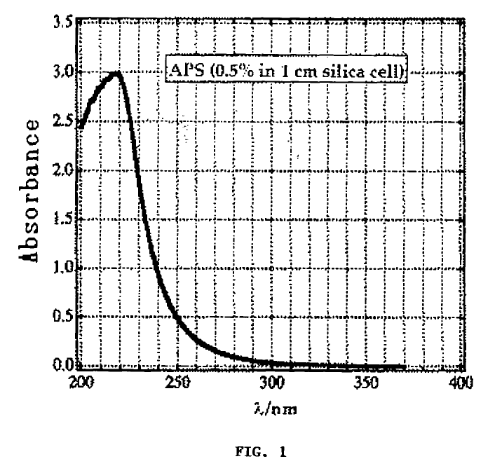

Non-limiting examples of persulfates that may be used include those chosen from ammonium persulfate, potassium persulfate, and sodium persulfate. Persulfates are substances which are usually used in combination with reducing agents, such as the above-mentioned redox initiators. However, in the present disclosure, the persulfates can be used without using reducing agents. These persulfates are believed to act as polymerization initiators by cleaving once they are irradiated with UV light. The absorption spectrum of ammonium persulfate in the wavelength 200-370 nm range of UV light is shown in FIG. 1.

The persulfates may be used in the aqueous solution in an amount ranging from 0.01-1.0% by weight, for example, 0.1-0.5%, by weight, such as 0.2-0.3% by weight, relative to the total weight of the composition. However, as with the concentration of the water-soluble vinyl monomer, the concentration may also be outside this range depending on the conditions or uses thereof.

It may also be mentioned that, in the present disclosure, the persulfates which may be conventionally used as oxidizing agents in the redox initiator may also be used for polymerization by light (UV radiation). The photopolymerization initiators that are conventionally used include compounds that are photocleaved to generate radicals such as benzoin ethers, acyl phosphine oxides and acyl phosphonates, and compounds which generate radicals by hydrogen drawing or by electron transfer, such as benzophenones, most of these being water-insoluble compounds having a benzene ring structure and often having toxicity or color. On the other hand, the persulfates that may be used in the present disclosure are water-soluble, safe to use, and colorless. Therefore, when producing the synthetic polymer hydrogel, the concentration of the persulfates can be adjusted over a wide range, thereby making it possible to adjust the speed of gelation, and the molecular weight and degree of crosslinking of the polymer.

The above-described persulfates and water-soluble vinyl monomers can generally be dissolved in water at room temperature.

While this aqueous solution may comprise additional ingredients other than the persulfates and water-soluble vinyl monomers depending on the uses thereof, such additional components should be used so as not to inhibit the gelation in accordance with the methods of the present disclosure.

Among such additional components, it is possible to mention, as non-limiting examples, pigments, nacres and/or fillers.

In an aspect of the disclosure, the prepared aqueous solution may be placed in a UV-permeable container of, for example, silica, and the aqueous solution is irradiated with UV light.

UV light is generally divided by wavelength into the UV-A region (wavelength ranging from about 320 to about 400 nm), the UV-B region (wavelength ranging from about 290 to about 320 nm) and the UV-C region (wavelength ranging from about 200 to about 290 nm). The present disclosure can use UV light throughout all ranges, but mention may be made of UV light in the UV-C region, such as UV light of short wavelengths ranging from about 200 to about 250 nm. The UV light irradiation time may differ according to the concentrations of persulfates and/or water-soluble vinyl monomers contained in the aqueous solution and the desired gelation rate. By way of non-limiting example, the irradiation time may range generally from 1 to 60 minutes, for instance, 3 to 45 minutes, such as 5 to 30 minutes.

By performing the operations disclosed herein, polymerization and crosslinking reactions will proceed in the aqueous solution in the container, and will gradually lose fluidity until the entire aqueous solution gels.

In an another aspect of the disclosure, an aqueous solution comprising at least one persulfate and at least one water-soluble vinyl monomer, as well as at least one of the aforementioned additional ingredients, is prepared as described above. Next, the solution is dispersed in a water-immiscible medium, for example, an organic solvent such as ethyl acetate, dichloromethane, petroleum ether and benzene, or an oil such as liquid paraffin, vegetable oil, animal oil, synthetic oil and mineral oil.

For example, mention may be made of:

hydrocarbon-based oils of animal origin;

hydrocarbon-based plant oils;

linear and/or branched hydrocarbons of mineral and/or synthetic origin;

synthetic esters and ethers of fatty acids;

fatty alcohols comprising from 12 to 26 carbon atoms; and

mixtures thereof.

This aspect of the disclosure includes both adding the aforementioned medium to the aqueous solution and stirring with a homogenizer to form a suspension, as well as using an appropriate surfactant (emulsifier) to emulsify the aqueous particles in the medium to form a water-in-oil type emulsion. The surfactant may be an ester of sorbitane and/or of glycerol; and an alkylester and/or an alkylether of sorbitane and/or glycerol. The suspension or emulsion may then be placed in a UV-transparent container as described above, and irradiated with UV light.

As a result of the procedures disclosed herein, synthetic polymer gel particles, for example, particles of a uniform size, dispersed in the medium can be obtained.

The method of the present disclosure does not use a reducing agent, such as a conventional redox initiator, this method allows for the production of dispersed synthetic polymer gel particles without disrupting the balance of the emulsion system.

The synthetic polymer gel particles created according to the disclosure can be separated from the medium as desired, in accordance with methods known in the relevant field. For example, the process of repeatedly adding a volatile organic solvent, such as hexane, to the medium comprising the generated synthetic polymer gel particles, and removing the supernatant fluid, and also removing the solvent by natural drying or freeze-drying, can be used to obtain the synthetic polymer gel particles. Another method that may be used is to put the medium in which the particles are dispersed under centrifugation to precipitate the particles, and remove the supernatant fluid. Additionally, for instance, when the synthetic polymer gel particles are relatively large in size, the medium in which the particles are dispersed can be spread out over a mesh with pores smaller than the particle size to remove the medium, then further cleansed with hexane or the like.

For example, by performing the method of the present disclosure on an aqueous solution (of vinyl monomers and persulfates) in a form having pigment, filler and/or nacre particles enclosed in the center (as a core) and dispersed in a medium to gel the aqueous solution, then separating the gelled particles, pigment particles having their surfaces protected by a synthetic polymer gel can thus be obtained. These coated particles comprising pigment, filler and/or nacre as a core and synthetic polymer gel as a shell can be useful in fields such as cosmetics.

The term “pigments” should be understood as meaning white and/or colored, mineral and/or organic particles intended to color and/or opacify the composition. The pigments may be of micrometric and/or nanometric size. Mineral pigments which may be mentioned include titanium dioxide, zirconium dioxide, cerium dioxide, zinc oxide, iron oxide, chromium oxide and ferric blue. Organic pigments which may be mentioned include carbon black, barium, strontium, calcium and aluminum lakes.

The term “fillers” should be understood as meaning colorless and/or white, mineral and/or synthetic, lamellar and/or non-lamellar particles that can give body and/or rigidity to the composition, and/or if desired, a softness, a matt effect and uniformity to a make-up result. Of possible fillers, mention may be made of talc, mica, silica, kaolin, Nylon powder, polyethylene powder, Teflon, starch, titanium mica, natural mother-of-pearl, boron nitride, microspheres such as Expancel (Nobel Industrie), Polytrap (Dow Corning) and silicone resin microbeads (Tospearls from Toshiba, for example).

The term “nacres” should be understood as meaning iridescent particles which reflect light. Among the nacres which may beused, mention may be made of mica coated with titanium oxide, with iron oxide, with natural pigment or with bismuth oxychloride, and also colored titanium mica.

The synthetic polymer gel particles and/or the dispersion comprising said gel and/or the pigments coated by said gel, may be used in cosmetic compositions.

They may be present in a composition in an amount which may readily be determined by a person skilled in the art depending on the desired effect, and for instance, ranging from 0.1% to 40% by weight, for example from 1% to 15% by weight, relative to the total weight of the composition, such as ranging from 24% to 12% by weight, or even from 4% to 10% by weight.

A cosmetic composition according to the disclosure could comprise at least one cosmetically or dermatologically acceptable oil, a fatty substance which is liquid at room temperature (25° C.). These oils may be chosen from hydrocarbon-based oils and/or silicone oils and/or fluoro oils. They may be of animal, plant, mineral or synthetic origin. The oils used can be volatile and/or non-volatile.

Mention may be made of suitable oils, for example:

hydrocarbon-based oils of animal origin such as perhydrosqualene;

hydrocarbon-based plant oils such as liquid triglycerides of fatty acids comprising from 4 to 10 carbon atoms, for instance heptanoic and/or octanoic acid triglycerides; sunflower oil, corn oil, soybean oil, marrow oil, grapeseed oil, groundnut oil, sweet almond oil, beauty-leaf oil, palm oil, sesame oil, hazelnut oil, apricot oil, macadamia oil, castor oil, avocado oil; caprylic/capric acid triglycerides, jojoba oil, karite butter;

linear and/or branched hydrocarbons of mineral and/or synthetic origin, such as liquid paraffins and derivatives thereof, petroleum jelly, polydecenes, and hydrogenated polyisobutene such as parleam;

synthetic esters and ethers, for example fatty acids, for instance the oils of formula R₃COOR₄ wherein R₃ represents a higher fatty acid residue comprising from 7 to 29 carbon atoms and R₄ represents a hydrocarbon-based chain comprising from 3 to 30 carbon atoms, such as, for example, purcellin oil (cetostearyl ocatanoate), isopropyl myristate, 2-ethylhexyl palmitate, 2-octyldodecyl stearate, 2-otyldodecyl erucate, isostearyl isostearate; hydroxylated esters such as isostearyl lactate, octyl hydroxystearate, octyldodecyl hydroxystearate, diisostearyl malate, triisocetyl citrate, and fatty alkyl heptanoates, octanoates and decanoates; polyol esters, for instance propylene glycol dioctanoate, neopentyl glycol diheptanoate or diethylene glycol diisononanoate; and pentaerythritol esters; tridecyl trimellitate;

fatty alcohols comprising from 12 to 26 carbon atoms, for instance octyldodecanol, 2-butyloctanol, 2-hexyldecanol, 2-undecylpentadecanol and oleyl alcohol;

partially hydrocarbon-based and/or silicone-comprising fluoro oils;

silicon oils, for instance volatile and/or non-volatile, linear and/or cyclic polymethylsiloxanes (PDMSs); alkyldimethicones; phenylsilicone oils;

mixtures thereof.

The composition may also comprise at least one wax that may be chosen from natural waxes of animal, plant and mineral origin, such as beeswax, montan wax, carnauba wax, candelilla wax, China wax, flax wax, pine wax, cotton wax, ouricury wax, lignite wax, rice bran wax, sugar cane wax, Japan wax, cork fibre wax; paraffin waxes, microcrystalline waxes, lanolin wax, ozokerites, hydrogenated oils with a melting point of greater than about 40° C., for instance hydrogenated jojoba oil, polyethylene waxes derived from the polymerization of ethylene, waxes obtained by Fischer-Tropsch synthesis, fatty acid esters and glycerides with a melting point of greater than about 40° C.; silicone waxes.

The composition according to the disclosure can additionally comprise one or more constituents usually used in the type of application envisaged such as:

organic solvents chosen, for example, from ketones, alcohols; glycols; propylene glycol ethers; short-chain esters (comprising from 3 to 8 carbon atoms); ethers; alkanes.

water, alone and/or in combination with hydrophilic active agents such as moisturizers, and/or hydrophilic gelling agents,

surfactants,

polymers, film-forming or not;

dyestuffs that may be chosen from lipophilic dyes, hydrophilic dyes, pigments and nacres usually used in cosmetic compositions, and mixtures thereof.

additives usually used in cosmetics, such as antioxidants, fragrances, essential oils, preserving agents, cosmetic active agents, vitamins, essential fatty acids, sphingolipids, self-tanning compounds such as DHA, sunscreens.

The compositions according to the disclosure may be applied to the skin of the face and of the body, to mucous membranes and to keratin fibres such as the nails, the eyelashes or the hair.

The compositions as disclosed herein can be in any envisageable cosmetic form, such as a solid or soft oily gel, optionally comprising water; a solid or gelled oil-in-water, water-in-oil or multiple emulsion; a dispersion of oil in water; a multi-phase system for example, a two-phase system. They can have the appearance of a cream, a salve, a soft paste, an ointment, a cast or moulded solid and for instance, a stick. They can be, for further example, in the form of a stick or a dish; such as in the form of a transparent anhydrous rigid gel, and for instance, in the form of a translucent or transparent anhydrous stick.

These compositions may be used, for example, as body hygiene compositions, for example in the form of deodorant sticks; as a hair composition, for example as a styling stick or a make-up stick for the hair; as a make-up composition for the skin of the face or the body or for mucous membranes, for example as a lipstick, a foundation cast as a stick or a dish, a face powder, an eyeshadow, a fixing base to be applied over a conventional lipstick, a concealer stick, a lip gloss, an eyeliner, a mascara or temporary tattoo products; as a care composition for the skin or mucous membranes, for example as a lipcare balm or base, an ointment for the body or a dally care cream; as an antisun composition or a self-tanning composition; as skin-care compositions such as creams or facial washing gel.

### EXAMPLES

Here below, the following specific examples serve to illustrate the disclosure, without limiting the aspects disclosed herein.

### Examples 1-7 and Comparative Examples 1-7

Aqueous solutions comprising 700-800 mM of the respective water-soluble vinyl monomers indicated in Table 1 and 0.2-0.3 wt % of ammonium persulfate were prepared.

The water-soluble vinyl monomers which were used had structures expressed by the following formula (II):

CH₂═CRₐR_{b} (II)

TABLE 1

| Ex- | Water-Soluble | In Formula (II) | | Gela- |
|---|---|---|---|---|
| amples | Vinyl Monomer | Rₐ | R_{b} | tion |
| Ex- | Acrylic Acid | H | COOH | ∘ |
| ample 1 | | | | |
| Ex- | Acrylamide | H | CONH₂ | ∘ |
| ample 2 | | | | |
| Ex- | N-isopropylacrylamide | H | CONHC₃H₇ | ∘ |
| ample 3 | | | | |
| Ex- | 2-(dimethyl- | H | COO(CH₂)₂N(CH₃)₂ | ∘ |
| ample 4 | amino)-ethylacrylate | | | |
| Ex- | N,N-dimethylacrylamide | H | CON(CH₃)₂ | ∘ |
| ample 5 | | | | |
| Ex- ample 6 | 4-acryloylmorpholine | H | 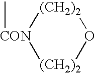 | ∘ |
| Ex- | 2-hydroxyethylacrylate | H | COO(CH₂)₂OH | ∘ |
| ample 7 | | | | |
| Com- | Mathacrylic acid | CH₃ | COOH | X |
| parative | | | | |
| Ex- | | | | |
| ample 1 | | | | |
| Com- | Methacrylamide | CH₃ | CONH₂ | X |
| parative | | | | |
| Ex- | | | | |
| ample 2 | | | | |
| Com- | N-vinylacatamide | H | NHCOCH₃ | X |
| parative | | | | |
| Ex- | | | | |
| ample 3 | | | | |
| Com- | Vinylacetic acid | H | CH₂COOH | X |
| parative | | | | |
| Ex- | | | | |
| ample 4 | | | | |
| Com- | N-vinylformamide | H | NHCOH | X |
| parative | | | | |
| Ex- | | | | |
| ample 5 | | | | |
| Com- parative Ex- ample 6 | N-vinylimidazole | H | 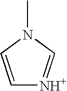 | X |
| Com- parative Ex- ample 7 | Sodium p-styrenesulfonate | H | 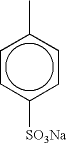 | X |

1 ml of each aqueous solution was placed in a silica cell of thickness 4 mm and width 1 mm, and irradiated for 5-30 minutes with UV light from a 500 W mercury lamp from a distance of about 20 cm.

The aqueous solutions of Examples 1-7 did not run even when the silica cells were tilted after irradiation with UV rays, whereas the aqueous solutions of Comparative Examples 1-7 maintained fluidity even after UV irradiation. These results are indicated in Table 1 by a “O” for those which lost fluidity and a “X” for those which maintained fluidity.

When irradiated under the same conditions via a filter for blocking UV light of wavelength 250 nm or less, the aqueous solutions of Examples 1-7 maintained their fluidity (gelation did not occur).

In the Examples, the gelation (loss of fluidity) was measured by tilting the silica cell by 180 degrees (inverting the cell) and observing the material in the cell. If the materials did not move after several minutes, it was determined that the materials were gelled (lost their fluidity), alternatively, if the materials moved, it was determined that the materials had not gelled (maintained their fluidity). Accordingly, a strict benchmark was employed in these examples in which deformable materials such as soft gels or viscous fluid were not considered to be gels in the examples. However, the process of the present disclosure can also produce such deformable gels, and manufacture of such deformable gels is included within scope of the present disclosure.

What is claimed is:

1. A method for producing a synthetic polymer gel comprising formulating an aqueous solution comprising at least one persulfate and at least one water-soluble vinyl monomer having an acryloyl structure, and
irradiating said aqueous solution with UV light.

2. The method according to claim 1, wherein the water-soluble vinyl monomer has a structure expressed by formula (I):
CH₂═CHCO—R (I)
wherein
R is an entity chosen from OH, R₁, OR₁, NH₂, NH-R₁ and N-R₁R₂,
wherein R₁ and R₂, which may be identical or different, may be chosen from straight, branched, and cyclic alkyl and alkoxyl groups comprising from 1 to about 10 carbon atoms, which may optionally comprise at least one hetero atom chosen from O, S and N in the chain, and may optionally be substituted with at least one entity chosen from halogen atoms, hydroxyl groups, carboxyl groups, formyl groups and amino groups.

3. The method according to claim 2, wherein the straight, branched, and cyclic alkyl and alkoxy groups comprise from 1 to about 8 carbon atoms.

4. The method according to claim 3, wherein the straight, branched, and cyclic alkyl and alkoxy groups comprise from 1 to about 6 carbon atoms.

5. The method according to claim 4, wherein the straight, branched, and cyclic alkyl and alkoxy groups comprise from 1 to about 4 carbon atoms.

6. The method according to claim 1, wherein the at least one persulfate is chosen from ammonium persulfate, potassium persulfate, and sodium persulfate.

7. The method according to claim 1, wherein the concentration of the water-soluble vinyl monomer in solution ranges from about 300 to about 1200 mM.

8. The method according to claim 1, wherein the at least one persulfate is present in an amount ranging from about 0.01 to about 1.0% by weight, relative to the total weight of the solution.

9. The method according to claim 1, wherein the wavelength of the UV light ranges from about 200 to about 290 nm.

10. The method according to claim 1, wherein the irradiation time ranges from about 1 to about 60 minutes.

11. A synthetic polymer gel produced by irradiating a formulated aqueous solution with UV light,
wherein said formulated aqueous solution comprises at least one persulfate and at least one type of water-soluble vinyl monomer having an acryloyl structure.

12. The synthetic polymer gel according to claim 11, wherein the water-soluble vinyl monomer has a structure expressed by formula (I):
CH₂═CHCO—R (I)
wherein
R is an entity chosen from OH, R₁, OR₁, NH₂, NH-R₁ and N-R₁R₂,
wherein R₁ and R₂, which may be identical or different, may be chosen from straight, branched, and cyclic alkyl and alkoxyl groups comprising from 1-10 carbon atoms, which may optionally comprise at least one hetero atom chosen from O, S and N in the chain, and may optionally be substituted with at least one entity chosen from halogen atoms, hydroxyl groups, carboxyl groups, formyl groups and amino groups.

13. The method according to claim 12, wherein the straight, branched, and cyclic alkyl and alkoxy groups comprise from 1 to about 8 carbon atoms.

14. The method according to claim 13, wherein the straight, branched, and cyclic alkyl and alkoxy groups comprise from 1 to about 6 carbon atoms.

15. The method according to claim 14, wherein the straight, branched, and cyclic alkyl and alkoxy groups comprise from 1 to about 4 carbon atoms.

16. The synthetic polymer gel according to claim 11, wherein the at least one persulfate is chosen from ammonium persulfate, potassium persulfate, and sodium persulfate.

17. The synthetic polymer gel according to claim 11, wherein the concentration of the water-soluble vinyl monomer in solution ranges from about 300 to about 1200 mM.

18. The synthetic polymer gel according to claim 11, wherein the at least one persulfate is present in an amount ranging from about 0.01 to about 1.0% by weight, relative to the total weight of the solution.

19. The synthetic polymer gel according to claim 11, wherein the wavelength of the UV light ranges from about 200 to about 290 nm.

20. The synthetic polymer gel according to claim 11, wherein the irradiation time ranges from about 1 to about 60 minutes.

21. A method for producing a dispersion of synthetic polymer gel particles comprising:
formulating an aqueous solution comprising at least one persulfate and at least one type of water-soluble vinyl monomer having an acryloyl structure,
dispersing said aqueous solution in a water-immiscible medium to form a suspension or water-in-oil type emulsion, and irradiating said suspension or water-in-oil emulsion with UV light.

22. A dispersion of synthetic polymer gel particles produced by
formulating an aqueous solution comprising at least one persulfate and at least one type of water-soluble vinyl monomer having an acryloyl structure,
dispersing said aqueous solution in a water-immiscible medium to form a suspension or water-in-oil type emulsion, and
irradiating said suspension or water-in-oil emulsion with UV light.

23. The method according to claim 21, further comprising separating generated synthetic polymer gel particles from said dispersion.

24. A synthetic polymer gel particle produced by the method of claim 23.

25. The method according to claim 1, wherein said formulated aqueous solution further comprises at least one additive chosen from pigments, fillers and nacre particles, such that after irradiation of the solution, the synthetic polymer gel particles comprise a core comprising the at least one additive.

26. The method according to claim 21, wherein said formulated aqueous solution further comprises at least one additive chosen from pigments, fillers, and nacre particles, such that after irradiation of the dispersion, the synthetic polymer gel particles comprise a core comprising the at least one additive.

27. The method according to claim 26, further comprising separating the generated synthetic polymer gel particles comprising a core comprising the at least one additive from said medium.

28. A synthetic polymer gel particle comprising a core comprising at least one additive chosen from pigments, fillers, and nacres, wherein said synthetic polymer gel particle is produced by the method of claim 27.

29. A cosmetic composition comprising a synthetic polymer gel, wherein said synthetic polymer gel is produced by
formulating an aqueous solution comprising at least one persulfate and at least one type of water-soluble vinyl monomer having an acryloyl structure, and
irradiating said aqueous solution with UV light.

30. A cosmetic composition comprising a dispersion of synthetic polymer gel, wherein said dispersion of synthetic polymer gel is produced by:
formulating an aqueous solution comprising at least one persulfate and at least one type of water-soluble vinyl monomer having an acryloyl structure,
dispersing said aqueous solution in a water-immiscible medium to form a suspension or water-in-oil type emulsion, and
irradiating said suspension or water-in-oil emulsion with UV light.

31. A cosmetic composition comprising a synthetic gel particle comprising a core comprising at least one additive chosen from pigments, fillers, and nacres, wherein said synthetic gel particle is produced by:
formulating an aqueous solution comprising at least one persulfate and at least one type of water-soluble vinyl monomer having an acryloyl structure, and at least one additive chosen from pigments, fillers, and nacres,
dispersing said aqueous solution in a water-immiscible medium to form a suspension or water-in-oil type emulsion,
irradiating said suspension or water-in-oil emulsion with UV light, and
separating the generated synthetic polymer gel particles comprising a core comprising the at least one additive from said medium.
